(19) United States
(12) Patent Application Publication
(10) Pub. No.: US 2018/0023703 A1
(43) Pub. Date: Jan. 25, 2018

(54) PISTON RING AND MANUFACTURING METHOD

(71) Applicant: GM Global Technology Operations LLC, Detroit, MI (US)

(72) Inventors: Ronald J. PETRUS, Lake Orion, MI (US); Zheng MA, Bloomfield Hills, MI (US); Qigui WANG, Rochester Hills, MI (US)

(21) Appl. No.: 15/216,367

(22) Filed: Jul. 21, 2016

(51) Int. Cl. F16J 9/20; F16J 9/26

(52) U.S. Cl. CPC F16J 9/20; F16J 9/26

(57) ABSTRACT

A piston ring includes a generally circular open ring having a generally cylindrical outer diameter surface and an inner diameter surface having a plurality of radially outwardly extending arcuate recesses. A method of making the piston ring includes extruding a rectangle cross-section steel wire to include at least two recesses in a side edge thereof. The extruded steel wire is wound in a ring-shape with the arcuate recesses being on an inner diameter surface of the wound ring.

### FIELD

The present disclosure relates to a piston ring and more particularly to a piston ring with high conformability for gas or diesel combustion engines.

### BACKGROUND AND SUMMARY

This section provides background information related to the present disclosure which is not necessarily prior art.

Piston rings are typically made from steel for many high performance engines. In general, steel is harder and it has a higher tensile and fatigue strength in comparison with ductile and grey cast iron. Steel piston rings can solve a lot of problems in highly stressed engines. They are stronger, harder, seal better and resist breakage and wear under load. They are ideal for any application that involves higher combustion temperatures, higher compression loads and tougher emission standards. The smaller cross section of a steel ring, permitted by the greater strength, also improves the ability of the ring to conform to less-than-perfect cylinder bores. Compared to ductile or cast-iron, the inherent high strength of steel creates less chance of ring breakage. Steel also provides longer service life.

The present disclosure provides improved piston ring conformability with the engine cylinder bore and provides a method of making the improved piston ring.

According to the present disclosure, a piston ring includes a generally circular open ring having a generally cylindrical outer diameter surface and an inner diameter surface having a plurality of radially outwardly extending arcuate recesses.

In addition, a method of making a piston ring is provided including extruding a rectangle cross-section steel wire to include two recesses in a side edge thereof and winding the extruded steel wire in a ring shape with the arcuate recesses being on an inner diameter surface of the wound ring.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a plan view of a piston ring according to the principles of the present disclosure;

FIG. 2 is a partial detail view of a piston ring with sinusoidal shaped recesses;

FIG. 3 is a partial detail view of a piston ring with different sized recesses;

FIG. 4 is a schematic illustration of a method of forming semi-circular shape undercuts on one side of a steel wire used for making piston rings according to the principles of the present disclosure;

FIG. 5 is a schematic illustration of an alternative method of forming semi-circular shape undercuts on one side of a steel wire used for making piston rings according to the principles of the present disclosure;

FIG. 6 is a schematic illustration of an alternative method of forming semi-circular shape undercuts of different sizes on one side of a steel wire used for making piston rings according to the principles of the present disclosure; and

FIG. 7 is a schematic illustration of a method of forming sinusoidal shape undercuts on one side of a steel wire used for making piston rings according to the principles of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

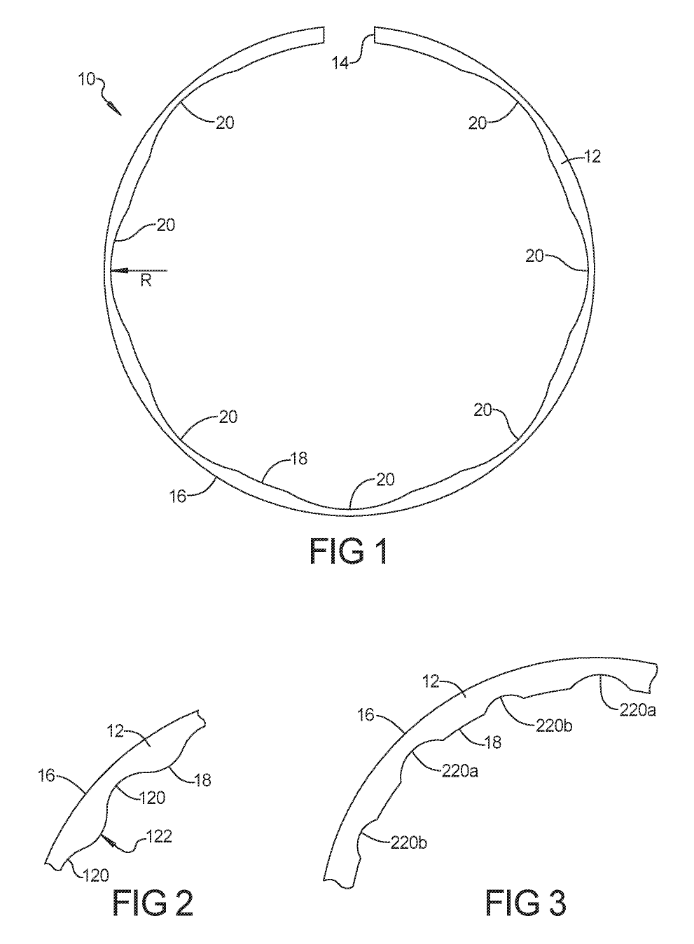

With reference to FIG. 1, a high conformability steel piston ring 10 is shown including a flat ring-shaped body 12 with an opening 14 therein. The ring-shaped body 12 includes a generally cylindrical outer diameter surface 16 and an inner diameter surface 18 that includes a plurality of radially outwardly extending arcuate recesses 20. The number of arcuate recesses 20 can range from 4 to 36. More preferably, 4 to 12 arcuate recesses 20 can be provided. As shown in FIG. 1, the plurality of arcuate recesses 20 can be formed by a generally continuous radius R. Alternatively, as shown in FIG. 2, the plurality of arcuate recesses 120 can be formed by a continuous sinusoidal curve 122. As a further alternative, as shown in FIG. 3, the arcuate recesses 220a, 220b can include arcuate recesses of different sizes or shapes such as longer arcuate recesses 220a and shorter arcuate recesses 220b.

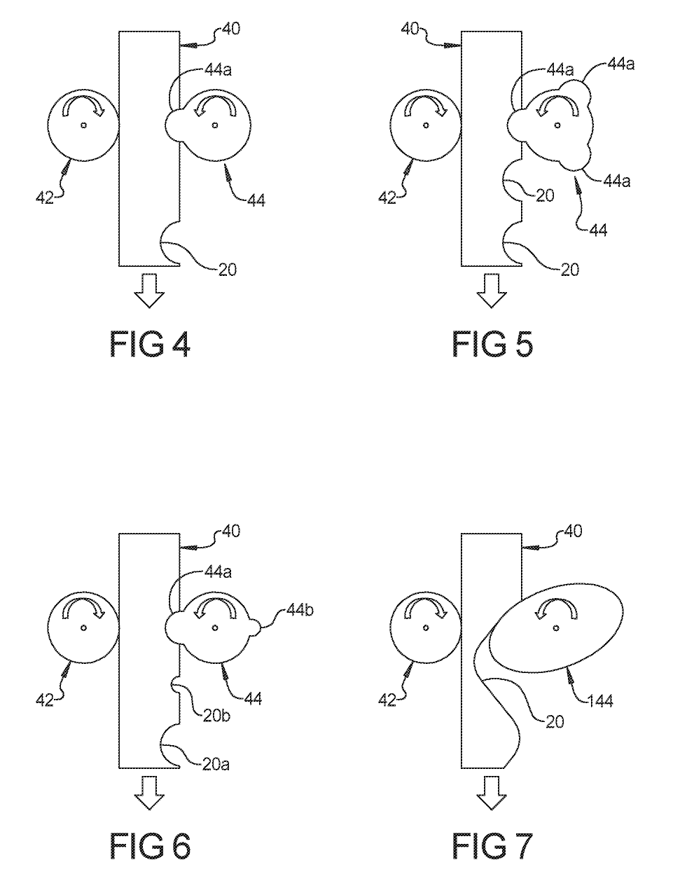

The high conformability steel piston rings 10 can be formed first by warm or cold extrusion of rectangle cross-section steel wire 40 to make uniform sinusoidal, radiused or other type shape undercuts or recesses on one side of the wire as illustrated in FIGS. 4-7 and then by winding the wire into the desired ring-shape with the sinusoidal, radiused or other type arcuate shape recesses on the ring inside diameter surface 18. Sinusoidal, radiused or other type shape recesses are formed by rolling the wire 40 between a cylindrical roller 42 on one side of the wire and a roller 44 having a partial circular or other shaped lobe 44a on the other side in a width direction.

FIG. 4 schematically shows how the semi-circular shape undercuts are formed on one side of the steel wire 40. As illustrated in FIG. 4, the spacing between the semi-circular shape undercuts 20 may be readily varied with different side roller 44 designs. As shown in FIG. 5, a plurality of semi-circular shape lobes 44a can be provided on the roller 44 for providing a higher density of recesses. Similarly, as shown in FIG. 6, the sizes of the recesses can be readily varied using different roller designs, and different shaped lobes 44a, 44b can be provided on a single roller 44 to provide different shaped arcuate recesses along the length of the inner diameter surface 18.

FIG. 7 illustrates how sinusoidal shape undercuts may be formed using specifically designed oval roller 144 as shown in FIG. 7. The size and geometry of the sinusoidal shape undercuts (amplitude and frequency) may be varied using different roller designs.

The winding of the formed wire 40 may be completed through either a hot or cold forming process. In hot winding, the rings 10 can be austenitized at 880 C±50 C, hot wound and oil quenched. After quenching, the rings 10 are tempered at 400 C±25 C. In the cold winding, the wire 40 is first induction-hardened at 950 C±50 C and tempered at 470 C±25 C and then wound at room temperature to the required sizes and possibly further stress relieved at 180 C±25 C.

To improve the steels durability (fatigue), if needed, the steel rings 10 may be shot-peened to produce compressive residual stress on the ring surfaces. In the shot peening process, 0.2-0.5 mm diameter ‘cut wire’ types of shots with hardness in the range of 610-670 HV are used. The shot peening intensity may be measured on a type A strip using the Almen test and the minimum and maximum values were 0.25 and 0.4 mm, respectively (curvature or deformation of the sheet). The shot peening duration may last 6-10 seconds and the coverage can be 99.9%.

To make the steel rings 10 compatible with cast iron liners (cylinder walls), at least the outer surfaces 16 of the steel rings 10, that contact the bore surfaces, may be coated with either chrome or molybdenum, PVD or DLC, or nitride. Prior to coating, the ring outer surface must be ground flat. Gas nitriding is a heat treatment process that impregnates the surface of the steel with nitrogen to case harden the steel surface. For steel rings 10, gas nitriding case hardens the entire surface of the ring 10 to a depth of about 25 μm which greatly improves its resistance to side wear as well as face wear.

Prior to coating, the steel ring outer surface should be ground flat. After extraction and rolling, as disclosed, the steel wire surfaces are usually flat. Unlike chrome, moly, PVD, or DLC coating, gas nitriding is a heat treatment process that impregnates the surface of the steel with nitrogen to case harden the steel surface.

The alloy for the steel rings may contain 0.5-0.6 wt % C, 1.2-1.6 wt % Si, −0.6-0.9 wt % Mn, 0.6-0.8 wt % Cr, 0.035 max P, 0.04 wt % max S and balance Fe.

The amount of machining that is required to finish a steel ring 10 is far less than that which is required to finish grey cast iron or ductile iron rings, particularly with the extruded steel wire. So, in general steel rings are actually less expensive to manufacture, at least in large batches. Most of the steel rings currently in production have a width of 1.2 mm, some are as small as 1.0 mm.

The high conformability of the disclosed piston rings 10 helps to improve oil consumption, blow by and to reduce piston ring tension. In addition, the high conformability provides improved performance. In addition, the manufacturing method reduces manufacturing cost as compared to other forms of feature manufacturing.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A piston ring, comprising:
a generally circular open ring having a generally cylindrical outer diameter surface and an inner diameter surface having a plurality of radially outwardly extending arcuate recesses.

2. The piston ring according to claim 1, wherein the plurality of arcuate recesses are formed by a generally continuous radius.

3. The piston ring according to claim 1, wherein the plurality of arcuate recesses are formed by a continuous generally sinusoidal curve.

4. The piston ring according to claim 1, wherein the plurality of arcuate recesses include arcuate recesses of different shapes.

5. The piston ring according to claim 1, wherein the plurality of arcuate recesses include at least four arcuate recesses.

6. The piston ring according to claim 1, wherein the plurality of arcuate recesses include no more than 36 arcuate recesses.

7. A method of making a piston ring, comprising:
extruding a rectangle cross-section steel wire to include at least four recesses in a side edge thereof; and
winding the extruded steel wire in a ring-shape with the arcuate recesses being on an inner diameter surface of the wound ring.

8. The method of making a piston ring according to claim 7, wherein the step of extruding a rectangle cross-section steel wire includes a roll forming extrusion wherein the arcuate recesses are formed by a roller having a non-cylindrical outer surface that engages the side edge of the rectangle cross-section steel wire.

9. The method of making a piston ring according to claim 8, wherein the non-cylindrical outer surface of the roller includes at least one arcuate protruding lobe.

10. The method of making a piston ring according to claim 8, wherein the non-cylindrical outer surface of the roller is oval-shaped.

11. The method of making a piston ring according to claim 7, wherein the wound ring is austenitized at between 830° C.-930° C. and oil quenched.

12. The method of making a piston ring according to claim 11, wherein the quenched ring is tempered at 400° C.±25 C.

13. The method of making a piston ring according to claim 7, wherein the wound ring is induction-hardened at between 900° C.-1000° C.

14. The method of making a piston ring according to claim 13, wherein the induction-hardened wound ring is then tempered at 470° C.±25 C.

15. The method of making a piston ring according to claim 7, wherein the wound ring is shot-peened.

16. The method of making a piston ring according to claim 7, wherein the wound ring is surface coated.
